(19) United States
(12) Patent Application Publication
(10) Pub. No.: US 2024/0247165 A1
(43) Pub. Date: Jul. 25, 2024

(54) METHOD FOR PROTECTING SENSITIVE SURFACES

(71) Applicant: SCHMITT PROF. MÖHLMANN & COLLEGEN WIRTSCHAFTSKANZLEI - INSOLVENZVERWALTER AKTIENGESELLSCHAFT, Zwickau (DE)

(72) Inventors: Jens SCHMITT, Zwickau (DE); Michaela MÜLLER, Stuttgart (DE)

(73) Assignee: SCHMITT PROF. MÖHLMANN & COLLEGEN WIRTSCHAFTSKANZLEI - INSOLVENZVERWALTER AKTIENGESELLSCHAFT, Zwickau (DE)

(21) Appl. No.: 18/566,246

(22) PCT Filed: May 30, 2022
(86) PCT No.: PCT/EP2022/064512

§ 371 Date: Dec. 1, 2023

(30) Foreign Application Priority Data
Jun. 1, 2021 (DE) 10 2021 114 110.9

(51) Int. Cl. C09D 105/04; C09D 105/08

(52) U.S. Cl. CPC C09D 105/04; C09D 105/08

(57) ABSTRACT

Method for the protection of sensitive surfaces of technical products from damage by applying a protective layer using alginate, characterized in that the surface is brought into contact with an aqueous alginate solution and an aqueous chitosan solution, with the chitosan solution containing metal ions.

The invention relates to a method for the protection of sensitive surfaces of technical products against damage by applying a protective layer using alginate and a protective coating produced therefrom.

It is common industrial practice to coat sensitive technical surfaces with film or sheeting to protect them against corrosion and damage. In this case plastic film is widely employed for this purpose which is removed and disposed of when the relevant products are delivered or sold. The surfaces to be protected are frequently paint coated surfaces, for example of motor vehicles. Polyalkylene-based films are very often used for this that are applied using an acrylate adhesive. Furthermore, paint coat protection films based on polyurethane are also known. Typical film thicknesses range between 50 and 150 μm, for paint protection films also with a thickness of up to 500 μm, with typical materials being polyethylene, polypropylene and polyurethane, each with an acrylic adhesive layer.

Especially in the case of motor vehicles, protective films of the type described hereinbefore offer limited protection only; on contact with hard objects, the protective film is often pierced causing the underlying paintwork to suffer damage.

Therefore, film coatings of this nature must on the one hand be associated with disadvantages regarding the expense and also the disposal of the plastic material. Having to peel off the plastic film or sheeting is an inconvenience generally and, if it has to be done before the product is delivered to customers, is also time consuming and costly. The film material as a rule is not biologically degradable but has to be recycled or disposed of otherwise.

Biodegradable protective films based on polylactate are known, however, they have not yet been able to become generally accepted. Protective coatings based on alginate are known from publication WO 2013/026581 A1. However, a disadvantage of alginate-based protective coatings is that they have a tendency to absorb water in a moist environment and the stickiness that results from this. Moreover, the use of alginate for the protection of food surfaces is known, and as well the use of an alginate solution for coating artificial lawn.

There is a need for protective coatings that do not have the disadvantages referred to above and, in particular, can be easily removed and disposed of by biodegradation.

It is, therefore, the objective of the present invention to coat scratch-sensitive surfaces with a protective film that can be easily degraded biologically, is not sticky, also withstands higher temperatures, and can be removed by means of water.

This objective is reached by providing a method of the kind first mentioned above, in which the surface is brought into contact with an aqueous alginate solution and an aqueous chitosan solution, with the chitosan solution containing metal ions, particularly bivalent metal ions such as calcium ions.

The method provided by the invention can be employed for all surfaces that shall be protected against damage, in particular scratching. However, the surfaces should be resistant to moisture. This is normally the case in the event of paint coated surfaces.

The above mentioned coating agents are natural, biodegradable polymers.

Alginic acid is a high-molecular natural product consisting of alpha-L-guluronic acid and beta-D-mannuronic acid, its mean molecular weight may range between about 40,000 and about 200,000. Guluronic acid and mannuronic acid are arranged in blocks (GG blocks and MM blocks). While the free acid, a white solid, is primarily insoluble in water the alkaline salts and in particular the sodium salt are water soluble. Solutions of up to seven percent can be prepared without difficulty but these may become viscous as the alginate concentration increases.

Alginic acid is produced by brown algae and some types of bacteria and is available in large quantities at low cost. A special property of alginates is the embedding of bivalent metal ions, for example Ca2+ ions, which takes place by forming a spatial structure and results in the gelation and precipitation of the alginate from the aqueous solution. The reaction is very fast and reversible; removing the calcium ions from the alginate matrix causes the alginate to become water soluble again and can thus be ‘washed off’. For example, EDTA can be used as a sequestering agent to release the calcium ions, but citrate or another chelating agent for calcium ions can also be employed.

The gelation may as well be induced by other metal ions, for example other alkaline earth metal ions, zinc ions, aluminum ions, and ferrous and ferric ions.

Alginate has hitherto been used in the foodstuff industry, in the pharmaceutical field (capsules), in the textile industry, in photographic paper manufacture, and for molding purposes. Alginate protective films for technical products have also been described, as indicated above.

Chitosan as well is a high-molecular natural product derived from chitin, which is composed of beta-1,4-glycosidically linked N-acetylglucosamine residues. It is obtained technically by alkaline or enzymatic deacetylation. The chitin is derived from the shells of crustaceans and is abundantly available. Chitosan comprises about 2000 repeating units of glucosamine. It is a colorless solid material which is soluble in water under acidic conditions; it solidifies again in a neutral or alkaline environment, resulting in the formation of films. It is non-toxic, antibacterial, antiviral and anti-allergenic. It is used, for example, as a coating agent in foodstuff and pharmaceutical products.

The method proposed by the present invention is based on the joint use of alginate and chitosan with a view to forming protective layers. The two polymers are introduced in an aqueous solution, with the alginate being usually dissolved in the form of sodium alginate and the chitosan in a low-percentage acetic acid solution. Each of the solutions preferably contain about 2 to 7% by volume of the respective polymer, in particular preferably between 3 and 6% by volume and especially about 5% by volume. The aqueous solution which is used to dissolve the chitosan contains between 3 and 6% and particularly about 5% by volume of acetic acid.

In the interest of keeping costs low, calcium ions are preferably used for the alginate gelation. In the process, the calcium ions are provided in the form of calcium carbonate, which is introduced into and dissolved in the acetic chitosan solution. Soluble calcium salts may also be utilized, for example in the form of calcium chloride, which is to be mixed into the chitosan solution. In the process of applying the solutions to the substrate to be coated—such as a motor vehicle—the calcium ions come into contact with the alginate and bring about its gelation.

In particular, for adding calcium to the alginate solution, calcium in the form of calcium carbonate or another insoluble calcium salt may also be used. Coming into contact with the acetic chitosan solution results in calcium ions being released which cause the alginate to gel. The carbon dioxide released in the process causes foam formation, which results in the protective effect being enhanced. Expediently, the overall content of calcium, calculated as calcium carbonate, is apportioned 15 to 40% by weight to the alginate solution and 60 to 85% by weight to the chitosan solution, in particular in a ratio of about 1:3.

In summary, to bring about the gelation of the alginate, a certain amount of calcium ions is necessary. Due to the fact that calcium incorporates into the structure of the GG blocks, the ratio of guluronic acid units to calcium ions should be approximately 1:1 at the molar level. Therefore, the molar ratio of the monomeric units of the alginate to the calcium ions thus expediently ranges between 1:1 to 8:1, in particular about 2:1. This ratio may vary slightly in accordance with the guluronic acid content of the alginate.

For the purpose of stabilizing the alginate and chitosan solutions used in each case, they may contain a preservation agent, for example agents that are customarily employed in the food industry, such as benzoic acid or sorbic acid. The content in the solutions ranges between approximately 0.05 and 0.5% by weight, based on the respective solution.

As proposed by the invention, the two polymer solutions can be applied simultaneously onto the surface to be protected, in particular by spraying. It is to be noted, however, that the solutions should only mix during the spraying process, preferably on the surface itself. In the event of the chitosan solution, application by spraying leads to evaporation of the aqueous phase and the acetic acid it contains, which contributes to film formation. Evaporation is accelerated by higher temperatures.

Building up the protective layer in steps is preferred, with an alginate layer being applied first, followed by a chitosan layer and, if considered necessary, further layers in the same sequence. Preferred is an alternating build-up of the protective layer of alginate and chitosan comprising four layers. Each layer has a thickness of between 5 and 25 μm with the total layer having a thickness of at least 30 μm.

Basically, the sequence of the layers is arbitrary, nevertheless, a top layer of chitosan offers advantages of counteracting the tendency of the gelated alginate to absorb water in a moist environment. This is due to chitosan being less susceptible to moisture. Alginate and chitosan form a network at the boundary layers that stabilizes the coating.

The ratio of alginate to chitosan in the protective layer appropriately ranges between 1:2 and 5:3, by weight, in particular is 1:1.

For the purpose of decoating the coated substrate, the chitosan layers are dissolved by spraying with 5% acetic acid and the alginate layers by using a 200 mmol citrate solution. This enables the coating to be completely washed off. The dissolved polymers are degraded in standard wastewater treatment plants.

Moreover, the invention also relates to a protective coating for sensitive surfaces that is based on alginate solidified with metal ions, said coating containing chitosan in addition to the solidified alginate.

The inventive protective coating can consist of a mixture of alginate and chitosan and may also comprise several layers of these materials. Preference is given to an alternating arrangement, with each alginate layer being followed by a chitosan layer. Such a protective coating consists of at least one underneath alginate layer and one upper chitosan layer, in particular, however, be composed of four layers in the sequence alginate, chitosan, alginate and chitosan. If considered necessary, additional layers may be applied.

The protective layers each have a thickness ranging between 5 and 25 μm, with a total layer thickness of at least 30 μm and up to 300 μm.

Preferably, the alginate layer contains calcium ions, which are essential for solidification. Together with the GG blocks of the alginate, calcium ions form a structure known as “egg box model” which is responsible for the precipitation of the alginate from the aqueous solution. The alginate is again made water-soluble and capable of being washed off by the addition of a sequestering agent, that is, an agent that enables the complexing of calcium ions to release them from their bond with alginate, for example EDTA or citrate.

The chitosan layer is formed by acid removal from the acetic solution. Applying a five-percent acetic solution to the chitosan layer results in the solubility to be re-established due to the protonation of the amino functions. The chitosan layer can be washed off as well. Instead of acetic acid any other acid can be used. Acetic acid offers advantages in that it is biodegradable.

It is advisable for the protective coating to contain an adequate amount of a standard preservation agent. This is the same agent that is added to the spray solutions for preservation and is partially included during precipitation of the layers.

To remove the protective coating, particularly if a layered build-up is provided, the agent suitable for the respective layer to be dissolved is applied by spraying and the layer washed off with water, i.e., using in the preferred embodiment initially five-percent acetic acid for the chitosan layer and a citrate solution—for example 200 mmol sodium citrate in water—for the alginate layer.

The protective layers may also contain other additives, for example mineral additives to increase strength, such as Aerosil 200 in an amount of 2% by weight, which is added to the alginate solution.

The protective layers proposed by the invention offer good adhesion to metallic and painted substrates as well as excellent scratch resistance compared to conventional protective films. The water absorption of the protective layers and in particular a swelling of the alginate layer are kept within acceptable limits, while providing a cover that consists of a chitosan layer being helpful. As a result of the suspension of calcium carbonate in the alginate solution, the carbon dioxide released during acid exposure may bring about foaming of the protective layer, which enhances the protective effect.

The protective layers are applied by spraying making use of spray guns or spraying systems, which are as well be used for the wash-off process. Curing takes place by drying, with a network forming between the alginate and chitosan at the boundary layers.

As regards the quality of the protective layer, two variants of the inventive method have proven to be particularly favorable. The first variant involves the admixture of calcium carbonate in the chitosan solution (which leads to the formation of calcium acetate) and the second includes the apportioning of calcium carbonate in a ratio of 1:3 by weight between the alginate and chitosan solution.

The protective layer is particularly suitable for the surface protection of new cars.

The invention is explained by way of the following examples.

Calcium ions, which were introduced into the solutions in the form of calcium carbonate, were used to bring about the gelation of the alginate solution. The calcium carbonate present in the alginate solution was dissolved by the acetic acid contained in the chitosan solution. The amount of calcium carbonate was calculated on the basis of the repeating units of the two uronic acids contained in the alginate, with n parts of calcium carbonate were used for 2n repeating units on a molar basis (2:1). In general, the ratio may range between 2:1 and 8:1.

### Example 1: Preparation of a Five Percent Chitosan Solution

10 g of chitosan (chitosan 90/60 from Biolog Heppe) were weighed into a 500 ml Schott flask and mixed with 190 g of 5-% acetic acid. The Schott flask was sealed and the mixture stirred until the chitosan was completely dissolved.

Variant 1: The entire amount of calcium carbonate, 2.827 g, was added to the chitosan solution and dissolved in it by stirring.

Variant 2: 75% of the calcium carbonate, 2.120 g, was added to the chitosan solution and dissolved in it.

The solutions were ready for use after the foaming process was completed. Benzoic acid in the amount of 0.4 g was added for preservation

### Example 2

10 g of alginate (8756 Welginat AD 1208 from Eurogum A/S) were weighed into a 500 ml Schott flask and mixed with 190 ml of deionized water. The Schott flask was sealed and the mixture stirred until the alginate was completely dissolved.

Variant 1: No calcium carbonate was added.

Variant 2: 25% of the calcium carbonate, 0.707 g, was added in powder form and suspended in the solution.

The solutions were then ready for use. Benzoic acid in the amount of 0.4 g was added for preservation.

### Example 3

The solutions obtained in this way were applied to paint-coated test panels in four layers using a spray gun, with a layer of alginate followed by a layer of chitosan. The total layer thickness amounted to 0.04 mm. The layers were dry after 4 to 5 hours at room temperature. Scratch tests using a spatula caused scratch marks on the protective coating, but these did not penetrate through to the test panel.

The coatings are largely water-resistant and can be washed off in four spray cycles with 5-% acetic acid and 200 mmol sodium citrate in water. The washing solutions are biodegradable.

1. A method for protection of sensitive surfaces of technical products against damage by applying a protective layer using alginate, characterized in that the surface is brought into contact with an aqueous alginate solution and an aqueous chitosan solution, the chitosan solution containing metal ions.

2. The method of claim 1, characterized in that the alginate solution and the chitosan solution are applied to the surface one after the other.

3. The method of claim 2, characterized in that two layers each of alginate and chitosan are alternately applied to the surface.

4. The method of claim 1, characterized in that calcium ions are used.

5. The method of claim 4, characterized in that the alginate solution contains calcium carbonate in fine-particulate suspended form of an insoluble salt.

6. The method of claim 5, characterized in that the alginate solution contains calcium carbonate in fine-particulate suspended form.

7. The method of claim 1, characterized in that the aqueous chitosan solution is an acetic solution containing 3 to 6% by volume of acetic acid.

8. The method of claim 1, characterized in that the alginate solution and the chitosan solution contain calcium ions, with the molar ratio of alginate, based on the repeating units, to the metal being 1:1 to 8:1, preferably 2:1.

9. The method of claim 1, characterized in that the overall content of calcium, calculated as calcium carbonate, is apportioned 15 to 40% by weight to the alginate solution and 60 to 85% by weight to the chitosan solution.

10. The method of claim 1, characterized in that the solutions contain between 0.05 and 0.5% by weight of a conventional preservation agent.

11. The method of claim 1, characterized in that alginate and chitosan are used in a weight ratio of between 1:1 and 5:3.

12. The method of claim 11, characterized in that the solutions contain between 0.05 and 0.5% by weight of a conventional preservation agent.

13. A protective coating for sensitive surfaces on the basis of alginate solidified with metal ions, characterized in that said protective coating including chitosan in addition to the solidified alginate.

14. The protective coating of claim 13, characterized in that it contains the solidified alginate and the chitosan in the form of layers.

15. The protective coating of claim 14, characterized in that it contains a chitosan layer applied on top of each alginate layer.

16. The protective coating of claim 13, characterized in that it comprises 4 layers.

17. The protective coating of claim 13, characterized in that the thickness of the coating is at least 30 μm.

18. The protective coating of claim 17, characterized in that each layer has a thickness ranging between 5 and 25 μm.

19. The protective coating of claim 13, characterized in that it contains a conventional preservation agent.

20. A method comprising:
preparing a protective coating for sensitive surfaces, from alginate and chitosan.

21. The protective coating of claim 14, characterized in that it comprises 4 layers.
